(19) United States
(12) Patent Application Publication
(10) Pub. No.: US 2025/0058386 A1
(43) Pub. Date: Feb. 20, 2025

(54) Manufacturing Process for Milling of Texture

(71) Applicant: Aridus Industries, Monongahela, PA (US)

(72) Inventor: Adam Roth, Monongahela, PA (US)

(21) Appl. No.: 18/802,252

(22) Filed: Aug. 13, 2024

Related U.S. Application Data
(60) Provisional application No. 63/519,366, filed on Aug. 14, 2023.

(51) Int. Cl. B23C 3/13

(52) U.S. Cl. CPC B23C 3/13

(57) ABSTRACT

A method is disclosed for manufacturing a texture on a surface of a material. An off-center cutting tool is configured with a number of off-center cutting edges. The off-center cutting tool is rotated at a selected rotation speed. The off-center cutting tool is fed across a surface of a material at a selected feed rate to mill the surface with the off-center cutting tool. The off-center cutting tool is configured with the number of off-center cutting edges, the rotation speed of the off-center cutting tool is selected, and the feed rate of the off-center cutting tool across the surface is selected to produce a texture in the surface in a single pass of the off-center cutting tool across the surface. The texture includes interleaved milled areas and unmilled areas in the surface.

### RELATED APPLICATIONS

This application claims the benefit of U.S. Provisional Patent Application Ser. No. 63/519,366, filed on Aug. 14, 2023, the content of which is incorporated by reference herein in its entirety.

### FIELD OF THE INVENTION

The teachings herein relate to methods for manufacturing a texture on the surface of a material. More particularly the teachings herein relate to methods for manufacturing a texture on a surface more efficiently by adjusting the feed rate, rotational speed, and number of cutting edges of an off-center cutting tool so that as the tool is run across the surface it does not remove all of the material. Instead, the off-center cutting edges make a textured circular rotational toolpath that includes interleaved milled areas and unmilled areas in the surface.

### BACKGROUND

Many firearms accessories, such as the handguards of rifles and shotguns for example, which are made of injection molded plastic, will have texture molded into the surfaces to provide grip for the user. Most handguards that are made of metal, such as computer numerical control (CNC) machined aluminum, have smooth surfaces that do not provide adequate gripping surfaces for the user. The workaround is generally to add additional pieces of rubber, textured plastic, etc. to the smooth aluminum surfaces to add grip. Some manufacturers machine texture into the aluminum using conventional machining methods and tooling.

FIG. 1 is an exemplary diagram 100 of a texture machined into an aluminum surface using conventional machining methods and tooling. In FIG. 1, texture 110 is machined into an aluminum surface 120 by milling away portions of aluminum surface 120.

In these conventional manufacturing processes, traditional milling tools are used. These tools (including but not limited to ball endmills or angled chamfer mills) are center cutting. The center of the tool will follow the center of each valley in order to machine the texture.

FIG. 2 is an exemplary diagram 200 of an angled chamfer mill used for center cutting. FIG. 3 is an exemplary diagram 300 of a ball endmill used for center cutting.

Because the center of a center cutting tool must travel through each valley, milling texture into handguards is rarely done as it is quite time-consuming and costly. In other words, it is a slow and expensive process in terms of the milling processes used to mill through each valley using a center cutting tool, like the tools shown in FIGS. 2 and 3.

As a result, there is an unmet need for new and novel methods for milling texture into surfaces. These new methods need to produce texture more quickly and at a lower cost in terms of developing and performing the manufacturing process.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is an exemplary diagram of a texture machined into an aluminum surface using conventional machining methods and tooling.

FIG. 2 is an exemplary diagram of an angled chamfer mill used for center cutting.

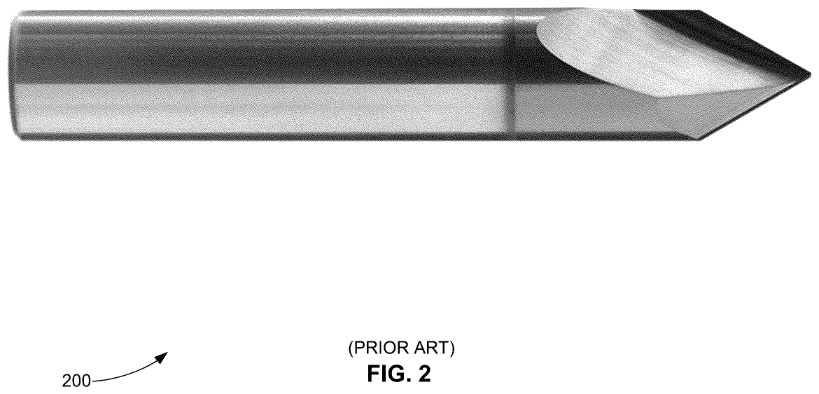

FIG. 3 is an exemplary diagram of a ball endmill used for center cutting.

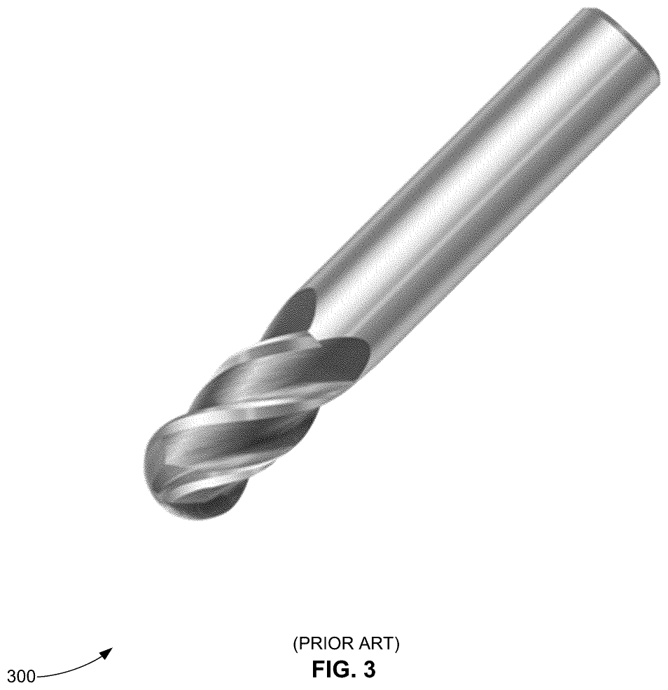

FIG. 4 is an exemplary diagram showing two different views of copy mills that include five removable round inserts, upon which various embodiments may be implemented.

FIG. 5 is an exemplary diagram showing a side view of a face mill that includes removable 45-degree inserts, upon which various embodiments may be implemented.

FIG. 6 is an exemplary diagram showing a texture milled in one single pass using an insert mill with a 45-degree insert, in accordance with various embodiments.

FIG. 7 is an exemplary diagram showing a texture milled in one single pass using an insert mill with an insert that is narrower and sharper than the insert used to mill the texture of FIG. 6, in accordance with various embodiments.

FIG. 8 is an exemplary diagram of a texture machined into an aluminum surface using an off-center cutting tool that milled the texture in a single pass, in accordance with various embodiments.

FIG. 9 is an exemplary diagram of an insert mill that includes only one off-center insert, in accordance with various embodiments.

FIG. 10 is an exemplary diagram showing a texture produced by rotating the insert mill of FIG. 9 at a cutting speed of 1575 rotations per minute (RPM) and translating the insert mill across a surface at a cutting feed rate of 250 inches per minute, in accordance with various embodiments.

FIG. 11 is an exemplary diagram showing the texture of FIG. 10 after the texture has been sandblasted, in accordance with various embodiments.

FIG. 12 is an exemplary flowchart showing a method for manufacturing a texture on a surface of a material, in accordance with various embodiments.

FIG. 13 is an exemplary flowchart showing a method for manufacturing a texture on a surface of a firearm accessory, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

As described above, many firearm accessories, such as the handguards of rifles and shotguns, have texture molded into their surfaces to provide grip for the user. Most handguards are made of metal and have smooth surfaces that do not provide adequate gripping surfaces for the user. Some manufacturers machine texture into the aluminum using conventional machining methods and tooling.

In these conventional manufacturing processes, traditional center-cutting milling tools are used. Because the center of a center cutting tool must travel through each valley, milling texture into handguards is rarely done as it is quite time-consuming and costly. In other words, it is a slow and expensive process in terms of the milling resources used to mill through each valley using a center-cutting tool.

As a result, there is an unmet need for new and novel methods for milling texture into surfaces. These new methods need to produce texture more quickly and at a lower cost in terms of developing and performing the manufacturing process.

In various embodiments, in order to efficiently mill texture into surfaces, an off-center tool with an off-center cutting edge is used. This tool can be of solid material. However, in various embodiments, an insert mill is used in the tooling. Insert mills, include, but are not limited to, copy mills, face mills, and fly cutters. These insert mills are typically made of steel and utilize replaceable carbide inserts that sit off-center. These inserts can be made in a wide variety of shapes and sizes.

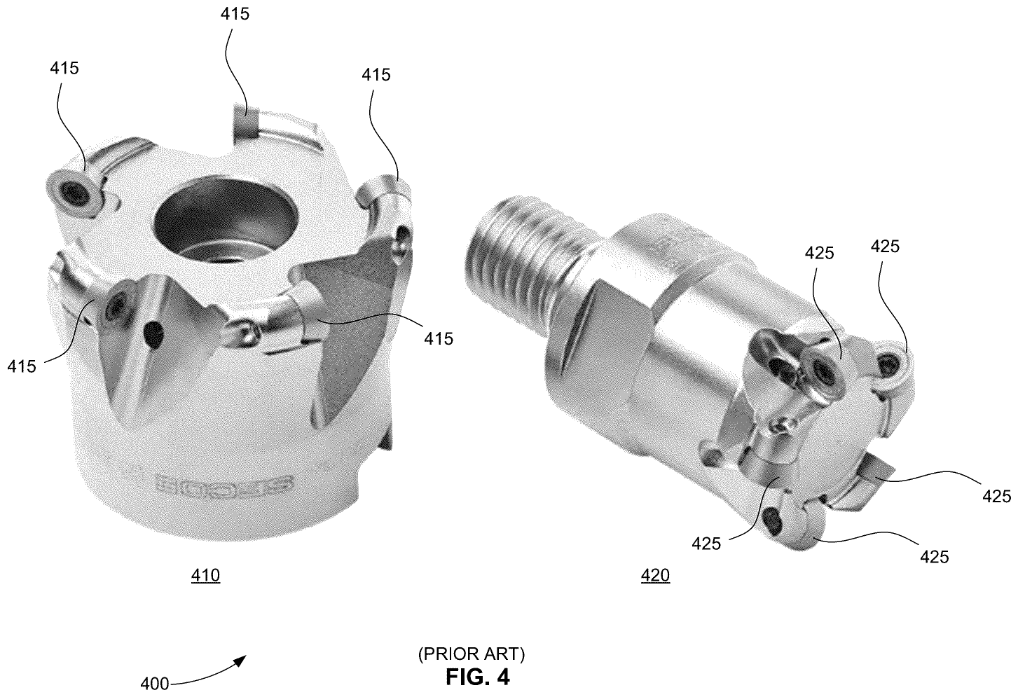

FIG. 4 is an exemplary diagram 400 showing two different views of copy mills that include five removable round inserts, upon which various embodiments may be implemented. View 410 is a top view of a copy mill and shows five round inserts 415 located off the central axis of the copy mill that the copy mill uses for milling. View 420 is a side view of a copy mill that also includes five round inserts 425 located off the central axis of the copy mill.

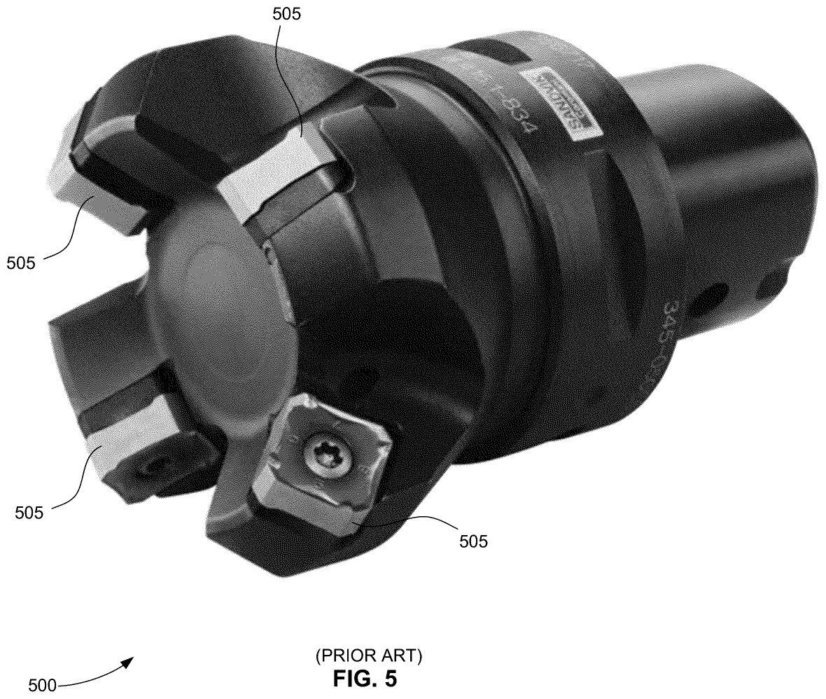

FIG. 5 is an exemplary diagram 500 showing a side view of a face mill that includes removable 45-degree inserts, upon which various embodiments may be implemented. In FIG. 5, the face mill includes four removable 45-degree inserts 505.

Conventionally, insert mills have multiple inserts and are run at feeds (the rate of travel) and speeds (the RPM the tool spins at) to leave a clean, smooth finish on the surface.

In various embodiments, however, the feeds, the speeds, and the number of inserts used are adjusted appropriately, so that as the tool is run across the surface it does not remove all of the material. Instead, the off-center cutters (inserts) make their circular rotational toolpath, cutting valleys (milled areas) and leaving peaks (unmilled areas).

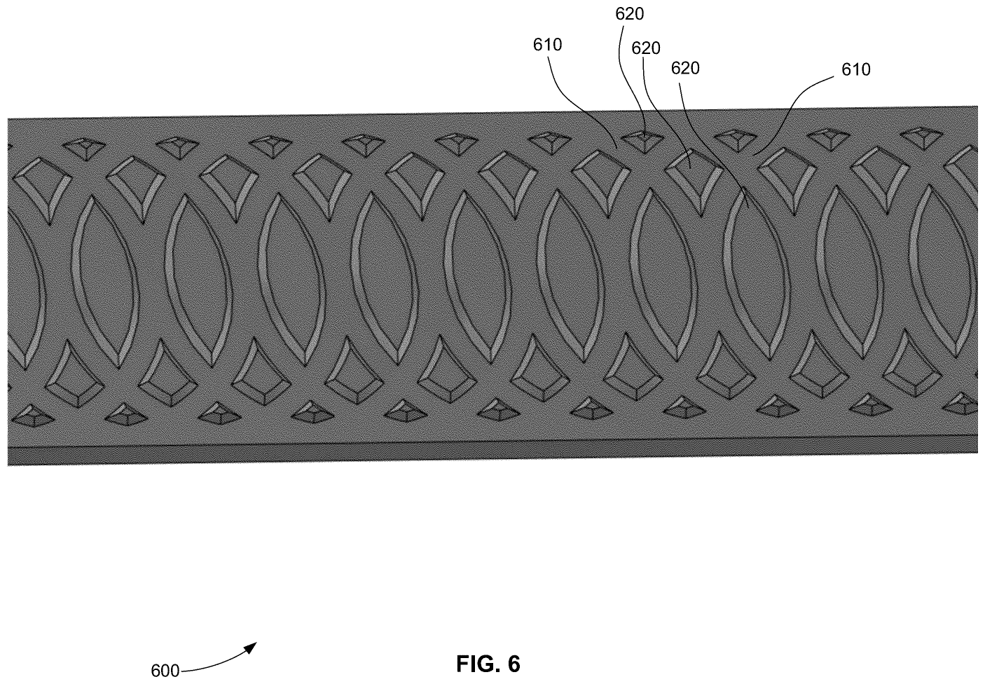

FIG. 6 is an exemplary diagram 600 showing a texture milled in one single pass using an insert mill with a 45-degree insert, in accordance with various embodiments. In FIG. 6, the texture is formed from interleaved milled areas 610 (valleys) and unmilled areas 620 (peaks).

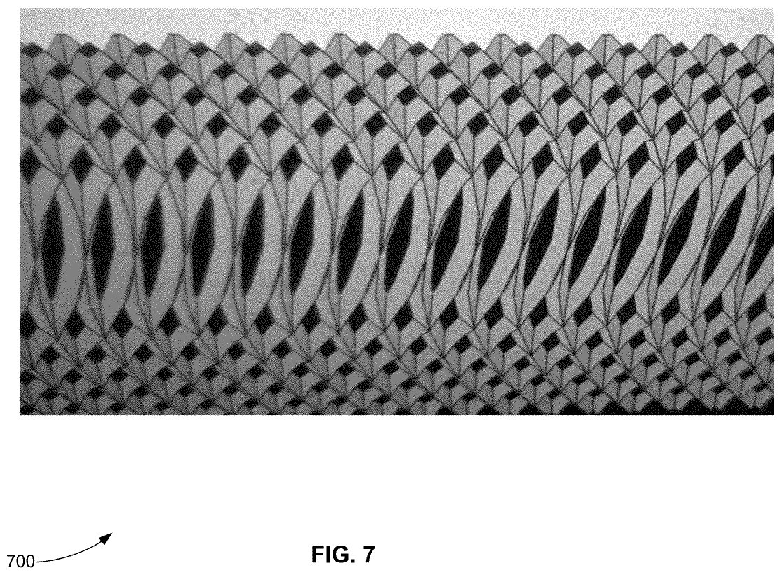

FIG. 7 is an exemplary diagram 700 showing a texture milled in one single pass using an insert mill with an insert that is narrower and sharper than the insert used to mill the texture of FIG. 6, in accordance with various embodiments. A comparison of FIGS. 6 and 7 shows that the narrower and sharper insert used to make the texture of FIG. 7 produces narrower valleys and peaks in the texture.

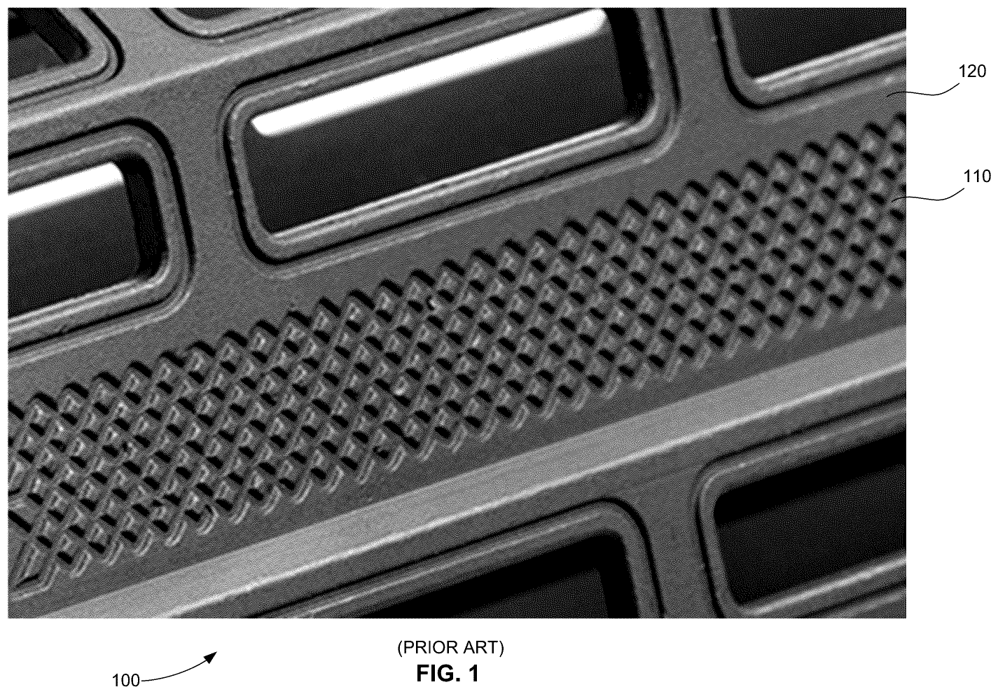

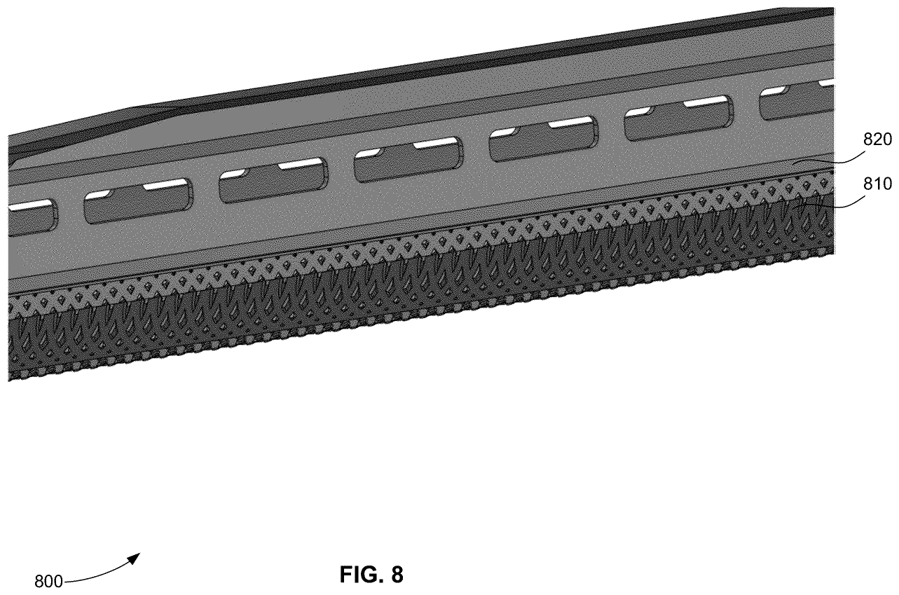

FIG. 8 is an exemplary diagram 800 of a texture machined into an aluminum surface using an off-center cutting tool that milled the texture in a single pass, in accordance with various embodiments. In FIG. 8, texture 810 is machined into an aluminum surface 820 by milling away portions of aluminum surface 820 with the off-center cutting tool. A comparison of FIGS. 1 and 8 shows that applying an off-center cutting tool in a single pass to a surface can provide a textured surface as well as traditional methods but with improved speed and efficiency.

In various embodiments, using an off-center cutting tool allows texture to be milled into each face very quickly with as little as one pass. What would take several minutes to machine with traditional milling methods can be accomplished in a matter of seconds. The end result is an accessory, in this particular example a handguard, that has texture machined into it. This provides much-needed grip for the user without having to add bulky additional components.

Although the method of applying an off-center cutting tool to produce a textured surface in a single pass of the tool is applied to firearms accessories in a preferred embodiment, various embodiments are not limited to firearms accessories. A similar texture can be manufactured in any type of material for any type of product. For example, a textured surface may be milled on a metal pan handle or on a wooden walking stick handle.

In various embodiments, an insert mill is modified to include just one off-center insert in order to produce a textured surface in a single pass of the insert mill. Reducing the number of inserts to one allows the insert mill to remove less material making it easier to produce a textured surface.

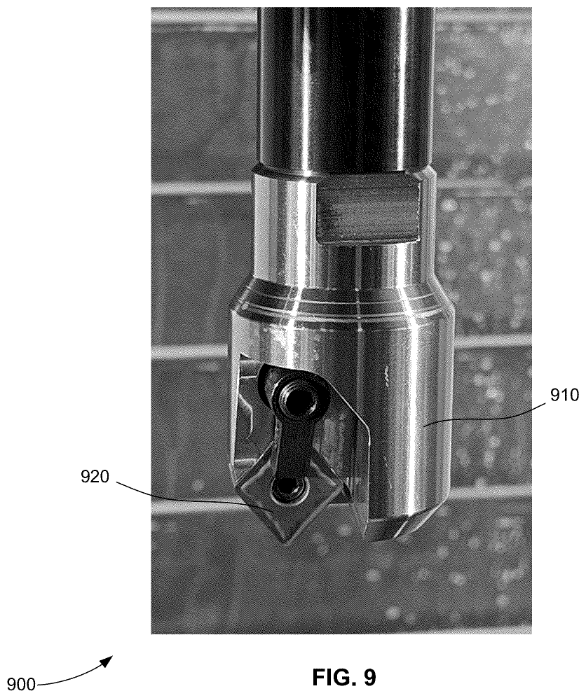

FIG. 9 is an exemplary diagram 900 of an insert mill that includes only one off-center insert, in accordance with various embodiments. Insert mill 910 of FIG. 9 includes a single off-center insert 920. Off-center insert 920 is the only part of insert mill 910 that is used for cutting the surface.

In one embodiment, insert mill 910 is designed to produce a 0.75-inch cut diameter. Off-center insert 920 has a 3/32-inch radius and 0.0175-inch depth of cut.

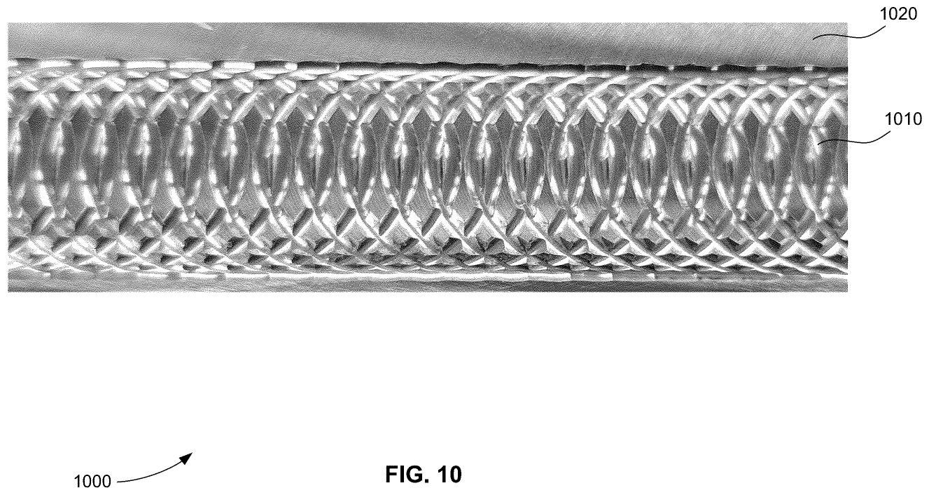

FIG. 10 is an exemplary diagram 1000 showing a texture produced by rotating the insert mill of FIG. 9 at a cutting speed of 1575 rotations per minute (RPM) and translating the insert mill across a surface at a cutting feed rate of 250 inches per minute, in accordance with various embodiments. In FIG. 1000, texture 1010 is machined into an aluminum surface 1020 by milling away portions of aluminum surface 1020 with the insert mill of FIG. 9 in a single pass.

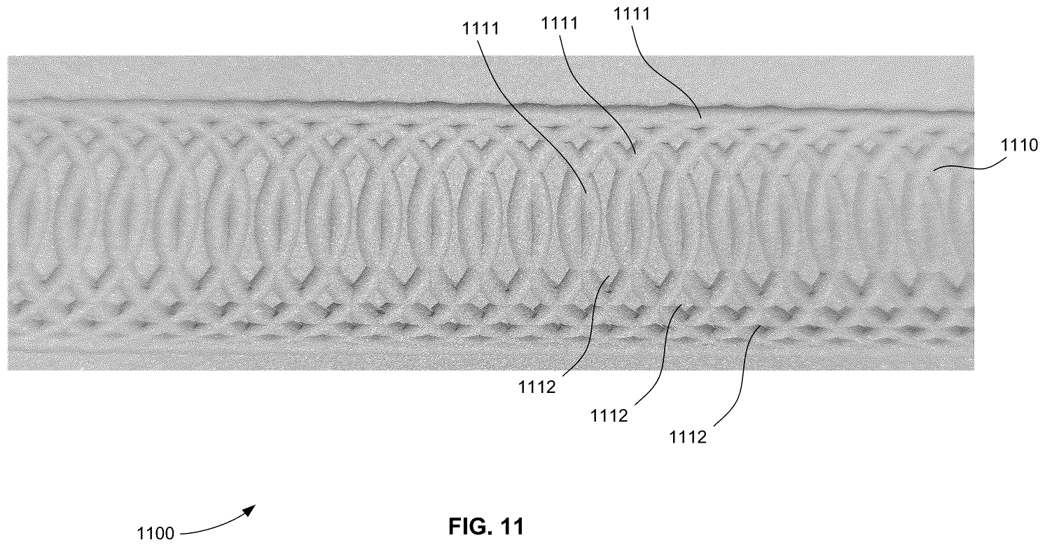

FIG. 11 is an exemplary diagram 1100 showing the texture of FIG. 10 after the texture has been sandblasted, in accordance with various embodiments. In FIG. 1100, sandblasted texture includes interleaved milled areas 1111 (valleys) and unmilled areas 1112 (peaks).

### Method for Manufacturing Texture on a Surface

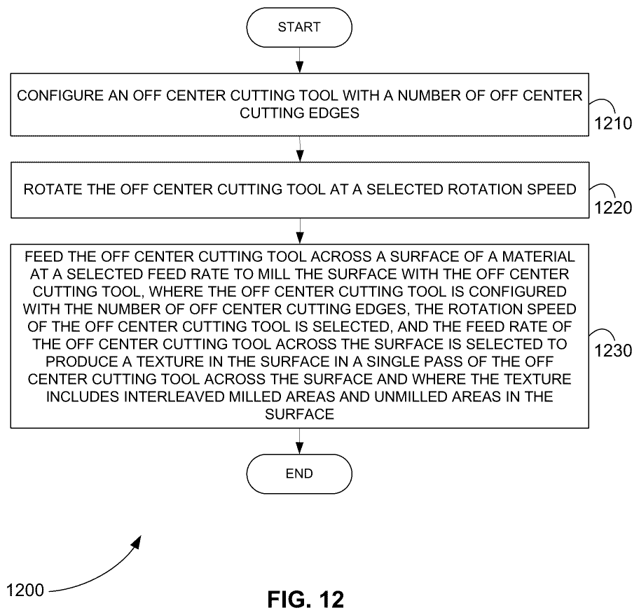

FIG. 12 is an exemplary flowchart showing a method 1200 for manufacturing a texture on a surface of a material, in accordance with various embodiments.

In step 1210 of method 1200, an off-center cutting tool is configured with a number of off-center cutting edges.

In step 1220, the off-center cutting tool is rotated at a selected rotation speed.

In step 1230, the off-center cutting tool is fed across a surface of a material at a selected feed rate to mill the surface with the off-center cutting tool. The off-center cutting tool is configured with the number of off-center cutting edges, the rotation speed of the off-center cutting tool is selected, and the feed rate of the off-center cutting tool across the surface is selected to produce a texture in the surface in a single pass of the off-center cutting tool across the surface. The texture includes interleaved milled areas and unmilled areas in the surface.

In various embodiments, the number of off-center cutting edges includes one. In various alternative embodiments, the number of off-center cutting edges includes two or more.

In various embodiments, the off-center cutting tool includes a solid material.

In various embodiments, the off-center cutting tool includes an insert mill and the number of off-center cutting edges includes one or more off-center replaceable carbide inserts that are located off-center of the insert mill.

In various embodiments, the insert mill includes one of a copy mill, a face mill, or a fly cutter.

In various embodiments, the one or more off-center replaceable carbide inserts include one insert. In various alternative embodiments, the one or more off-center replaceable carbide inserts include two or more inserts.

In various embodiments, the one or more off-center replaceable carbide inserts include one or more round inserts.

In various embodiments, the one or more off-center replaceable carbide inserts include one or more 45-degree inserts.

In various embodiments, the off-center cutting tool is rotated and fed across the surface using a computer numerical control (CNC) machine.

In various embodiments, the material includes a firearm accessory. In various embodiments, the firearm accessory includes a handguard.

In various embodiments, the material includes aluminum.

### Method for Manufacturing Texture on a Firearm Accessory

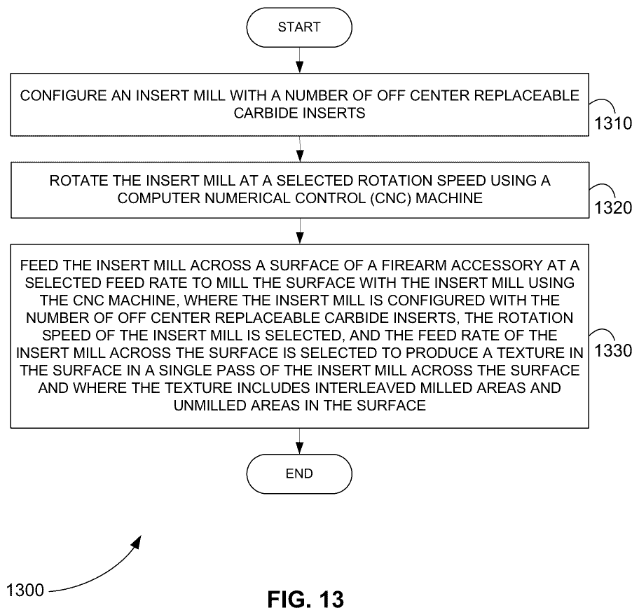

FIG. 13 is an exemplary flowchart showing a method 1300 for manufacturing a texture on a surface of a firearm accessory, in accordance with various embodiments.

In step 1310 of method 1300, an insert mill is configured with a number of off-center replaceable carbide inserts.

In step 1320, the insert mill is rotated at a selected rotation speed using a computer numerical control (CNC) machine.

In step 1330, the insert mill is fed across a surface of a firearm accessory at a selected feed rate to mill the surface with the insert mill using the CNC machine, where the insert mill is configured with the number of off-center replaceable carbide inserts, the rotation speed of the insert mill is selected, and the feed rate of the insert mill across the surface is selected to produce a texture in the surface in a single pass of the insert mill across the surface and where the texture includes interleaved milled areas and unmilled areas in the surface.

In various embodiments, the number of off-center replaceable carbide inserts includes one.

In various embodiments, the firearm accessory includes a handguard.

In various embodiments, the firearm accessory includes aluminum.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A method for manufacturing a texture on a surface of a material, comprising:
configuring an off-center cutting tool with a number of off-center cutting edges;
rotating the off-center cutting tool at a selected rotation speed;
feeding the off-center cutting tool across a surface of a material at a selected feed rate to mill the surface with the off-center cutting tool,
wherein the off-center cutting tool is configured with the number of off-center cutting edges, the rotation speed of the off-center cutting tool is selected, and the feed rate of the off-center cutting tool across the surface is selected to produce a texture in the surface in a single pass of the off-center cutting tool across the surface and wherein the texture includes interleaved milled areas and unmilled areas in the surface.

2. The method of claim 1, wherein the number of off-center cutting edges comprises one.

3. The method of claim 1, wherein the number of off-center cutting edges comprises two or more.

4. The method of claim 1, wherein the off-center cutting tool comprises a solid material.

5. The method of claim 1, wherein the off-center cutting tool comprises an insert mill and the number of off-center cutting edges comprises one or more off-center replaceable carbide inserts that are located off-center of the insert mill.

6. The method of claim 5, wherein the insert mill comprises a copy mill.

7. The method of claim 5, wherein the insert mill comprises a face mill.

8. The method of claim 5, wherein the insert mill comprises a fly cutter.

9. The method of claim 5, wherein the one or more-off-center replaceable carbide inserts comprise one insert.

10. The method of claim 5, wherein the one or more off-center replaceable carbide inserts comprise two or more inserts.

11. The method of claim 5, wherein the one or more off-center replaceable carbide inserts comprise one or more round inserts.

12. The method of claim 5, wherein the one or more off-center replaceable carbide inserts comprise one or more 45-degree inserts.

13. The method of claim 1, where the off-center cutting tool is rotated and fed across the surface using a computer numerical control (CNC) machine.

14. The method of claim 1, wherein the material comprises a firearm accessory.

15. The method of claim 10, wherein the firearm accessory comprises a handguard.

16. The method of claim 1, wherein the material comprises aluminum.

17. A method for manufacturing a texture on a surface of a firearm accessory, comprising:
configuring an insert mill with a number of off-center replaceable carbide inserts;
rotating the insert mill at a selected rotation speed using a computer numerical control (CNC) machine;
feeding the insert mill across a surface of a firearm accessory at a selected feed rate to mill the surface with the insert mill using the CNC machine,
wherein the insert mill is configured with the number of off-center replaceable carbide inserts, the rotation speed of the insert mill is selected, and the feed rate of the insert mill across the surface is selected to produce a texture in the surface in a single pass of the insert mill across the surface and wherein the texture includes interleaved milled areas and unmilled areas in the surface.

18. The method of claim 17, wherein the number of off-center replaceable carbide inserts comprises one.

19. The method of claim 17, wherein the firearm accessory comprises a handguard.

20. The method of claim 17, wherein the firearm accessory comprises aluminum.
